(19) United States
(12) Patent Application Publication
(10) Pub. No.: US 2010/0080404 A1
(43) Pub. Date: Apr. 1, 2010

(54) DRIVE UNIT MANUFACTURING METHOD AND DRIVE UNIT

(75) Inventors: Ryuzo Tamayama, Kanagawa (JP); Satoshi Arai, Kanagawa (JP); Masaru Yajima, Saitama (JP); Koji Sakata, Saitama (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/567,843

(22) Filed: Sep. 28, 2009

(30) Foreign Application Priority Data
Sep. 29, 2008 (JP) 2008-251756

(51) Int. Cl. H04R 3/00; H04R 31/00

(52) U.S. Cl. 381/111; 381/150; 29/594

(57) ABSTRACT

The present invention provides a drive unit manufacturing method including the steps of: preparing a conducting wire which contains at least copper and forms a voice coil for conversion between sound and electric signals and arranging the conducting wire on a land which is formed on a board that the voice coil is arranged on and is provided for transmitting the electric signals; and connecting the conducting wire and the land by resistance welding.

### BACKGROUND OF THE INVENTION

1. Field of the Invention

The present invention relates to a drive unit manufacturing method and a drive unit.

2. Description of the Related Art

In recent years, there are growing demands for enjoying sound like music in various scenes and to meet these demands, various sound reproducing apparatuses have been developed. Users can bring such a sound reproducing apparatus with them and listen to sound wherever and whenever they want. As more often users bring such sound reproducing apparatuses with them, portability of such sound reproducing apparatuses becomes more important. In order to enhance portability, various apparatuses are getting more and more miniaturized.

### SUMMARY OF THE INVENTION

Such miniaturization of apparatuses depends on progress of the technique which allows finer-line circuits to be formed on a printed board or the like. However, a drive unit, which is equivalent to a sound output part such as a speaker or microphone, has such a structure that fine voice coil, magnets and the like are arranged inside. This voice coil is hard to be integrally formed on the printed board by printing. Then, the voice coil itself needs to be connected to the printed board.

As disclosed in the Japanese Patent Application Laid-Open No. 2000-358297, connection of such a voice coil and the board or the like is often performed by soldering and performed manually by workers. However, the diameter of a conducting wire that forms the voice coil is extremely smaller as a speaker and a microphone are miniaturized more. This makes the optimal conditions of soldering very severe for workers who have little experience. Hence, soldering can be performed by the limited skilled workers. Thus, manual soldering imposes large burden on the workers and much efforts are required for making the workers skilled in order to enhance the reliability. Besides, it is also required to consider any human errors and it is difficult to maintain the constant quality.

Then, the present invention has been carried out in view of the foregoing, and provides a drive unit manufacturing method and a drive unit capable of enhancing the product quality more than usual while reducing burden on manufacturers.

According to an embodiment of the present invention, there is provided, a drive unit manufacturing method including the steps of: preparing a conducting wire which contains at least copper and forms a voice coil for conversion between sound and electric signals and arranging the conducting wire on a land which is formed on a board that the voice coil is arranged on and is provided for transmitting the electric signals; and connecting the conducting wire and the land by resistance welding.

According to this structure, the conducting wire of the voice coil can be connected to the land of the board by resistance welding. Hence, connection can be preformed more easily and accurately as compared with the case where connection is performed by workers' manual soldering.

Further, the step of connecting of the conducting wire and the land may include: arranging a heating element on the conducting wire arranged on the land; pressing the heating element toward the conducting wire and the land by use of a welding head having a pair of electrodes; preheating the conducting wire and the land by supplying first power to the welding head pressing and thereby supplying the first power to the heating element to generate heat; and full-heating the conducting wire and the land by supplying second power to the welding head pressing and thereby supplying the second power to the heating element to generate heat.

A pressing force in the step of pressing may be 0.1 N or more and 3.0 N or less.

A time for applying the second power in the step of full-heating may be 10 msec or more and 1000 msec or less.

The second power supplied to the welding head in the step of full-heating may be 10 W or more and 60 or less.

In the step of full-heating, the second power may be supplied in form of discontinuous pulses.

A heating stop step of stopping power supply to the welding head may be provided between the steps of preheating and full-heating.

The conducting wire may have a diameter of 70 μm or less.

According to another embodiment of the present invention, there is provided, a drive unit including: a land which is formed on a board where a voice coil for conversion between sound and electric signals is arranged and is provided for transmitting the electric signals; and a conducting wire which contains at least copper to form the voice coil and is connected to the land, wherein the conducting wire and the land are connected to each other by resistance welding.

As described up to this point, according to the present invention, it is possible to reduce the burdens on manufacturing workers and improve the product quality more than usual.

### BRIEF DESCRIPTION OF THE DRAWINGS

FIG. 1 is an explanatory view for explaining an outline structure of a headphone according to a first embodiment of the present invention;

FIG. 2 is an explanatory view for explaining a drive unit according to the embodiment;

FIG. 3 is an explanatory view for explaining a conducting wire according to the embodiment;

FIG. 4 is an explanatory view for explaining welding of the conducting wire and the land in the drive unit according to the embodiment;

FIG. 5 is an explanatory view for explaining a structure of a drive unit manufacturing apparatus according to the embodiment;

FIG. 6 is an explanatory view for explaining an operation of the drive unit manufacturing apparatus according to the embodiment;

FIG. 7 is an explanatory view for explaining the operation of the drive unit manufacturing apparatus according to the embodiment;

FIG. 8 is an explanatory view for explaining the operation of the drive unit manufacturing apparatus according to the embodiment;

FIG. 9 is an explanatory view for explaining the operation of the drive unit manufacturing apparatus according to the embodiment;

FIG. 10 is an explanatory view for explaining the operation of the drive unit manufacturing apparatus according to the embodiment;

FIG. 11A is an explanatory view for explaining the pressuring operation of the drive unit manufacturing apparatus according to the embodiment;

FIG. 11B is an explanatory view for explaining the pressuring operation of the drive unit manufacturing apparatus according to the embodiment;

FIG. 11C is an explanatory view for explaining the pressuring operation of the drive unit manufacturing apparatus according to the embodiment;

FIG. 11D is an explanatory view for explaining the pressuring operation of the drive unit manufacturing apparatus according to the embodiment;

FIG. 11E is an explanatory view for explaining the pressuring operation of the drive unit manufacturing apparatus according to the embodiment;

FIG. 11F is an explanatory view for explaining the pressuring operation of the drive unit manufacturing apparatus according to the embodiment;

FIG. 11G is an explanatory view for explaining the pressuring operation of the drive unit manufacturing apparatus according to the embodiment;

FIG. 11H is an explanatory view for explaining the pressuring operation of the drive unit manufacturing apparatus according to the embodiment;

FIG. 12A is an explanatory view for explaining the full-heating operation of the drive unit manufacturing apparatus according to the embodiment;

FIG. 12B is an explanatory view for explaining the full-heating operation of the drive unit manufacturing apparatus according to the embodiment;

FIG. 13A is an explanatory view for explaining the full-heating operation of the drive unit manufacturing apparatus according to the embodiment; and

FIG. 13B is an explanatory view for explaining the full-heating operation of the drive unit manufacturing apparatus according to the embodiment.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

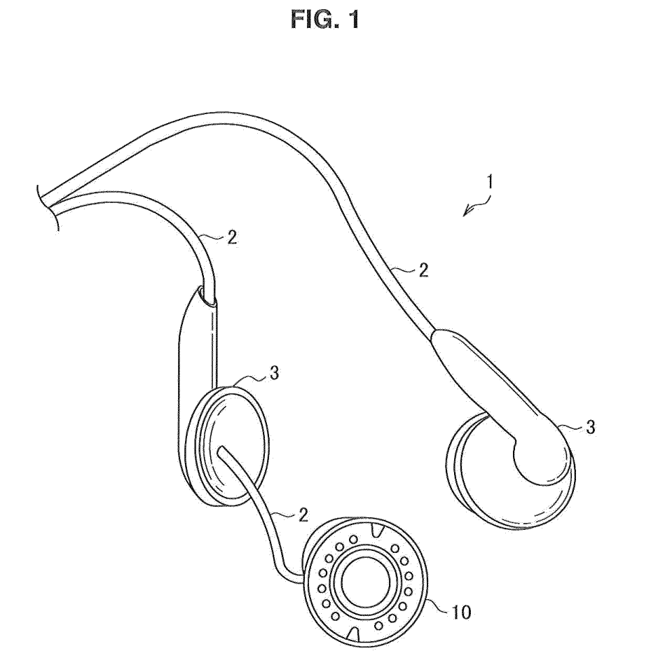

With the drive unit manufacturing method according to the embodiments of the present invention, it is possible to manufacture a drive unit provided in a headphone or a speaker for outputting sound or a drive unit provided in a microphone for inputting sound. These drive unit are used as units having structures that use magnets, voice coils and the like and are almost common to headphones, speakers and microphones. Then, the drive unit manufacturing method according to each embodiment of the present invention will be described by way of example of manufacturing the drive unit for headphone. However, needless to say, the drive unit manufacturing method according to each embodiment of the present invention can be applied to a speaker and a microphone in the same manner. Besides, in the following description, the term “headphone” used here includes “earphone” (see FIG. 1) in a broad sense.

Further, in a drive unit manufactured by the drive unit manufacturing method according to embodiments of the present invention, the voice coil is connected to the board by resistance welding not by soldering. This resistance welding will be explained with the drive unit manufacturing method described later. Besides, in advance of explanation of the drive unit manufacturing method, the drive unit of a headphone and the drive unit manufacturing apparatus will be described. That is, description here will be given in the following order so as to facilitate understanding of the drive unit manufacturing method and the like according to the embodiments of the present invention.

### First Embodiment

[1. Drive Unit of Headphone]
[2. Drive Unit Manufacturing Apparatus]
[3. Drive Unit Manufacturing Method]
[4. Example of Effects of First Embodiment]

### [1. Drive Unit of Headphone]

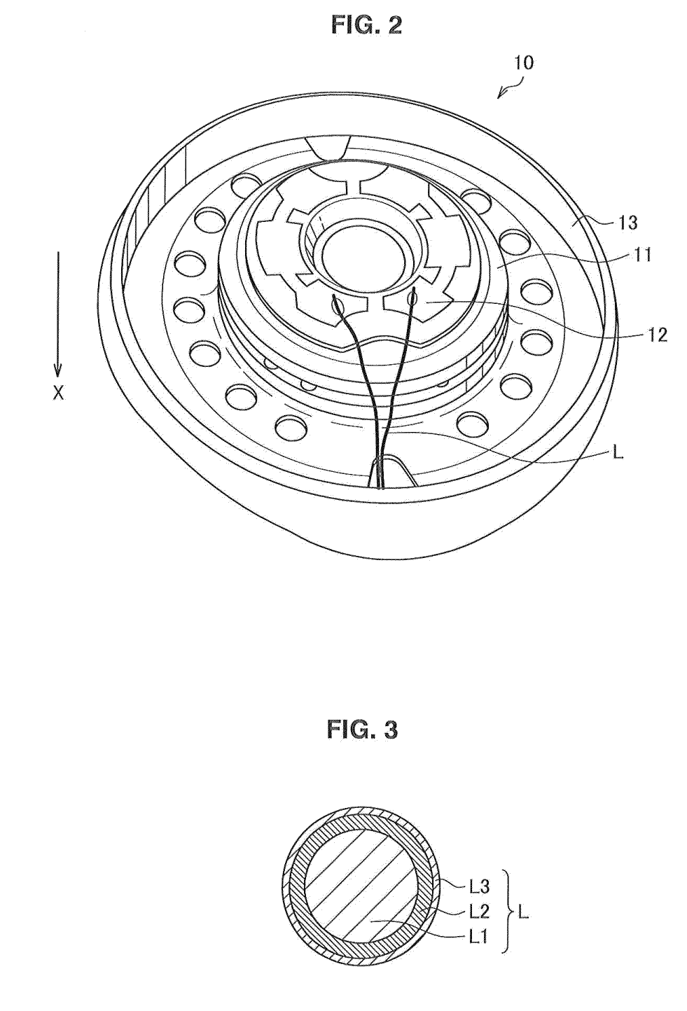

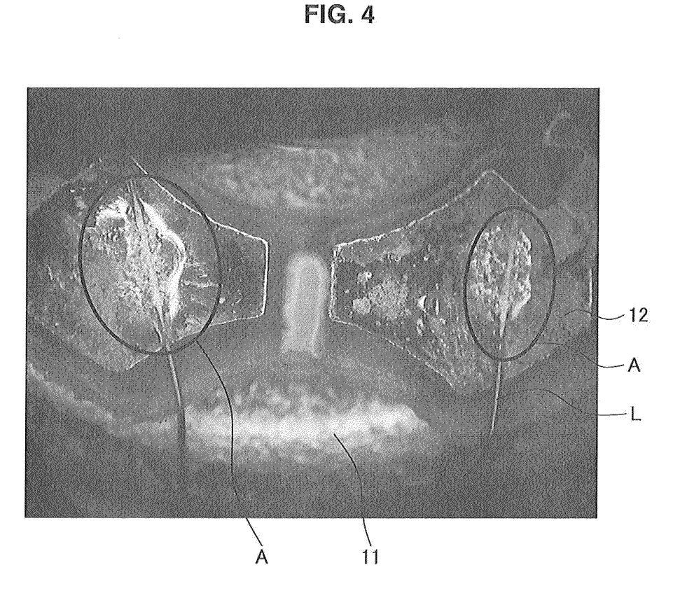

First description is made, with reference to FIGS. 1 to 4, about a drive unit according to a first embodiment of the present invention. FIG. 1 is an explanatory view for explaining the outline structure of a headphone according to a first embodiment of the present invention. FIG. 2 is an explanatory view for explaining a drive unit according to the present embodiment. FIG. 3 is an explanatory view for explaining a conducting wire according to the present embodiment, and FIG. 4 is an explanatory view for explaining welding between the conducting wire and a land in the drive unit according to the present embodiment.

FIG. 1 shows the structure of the inner ear type headphone 1. Such an inner ear type headphone 1 is miniaturized as it is mounted on a user's ear or inserted in into the ear. The drive unit 10 according to the present embodiment can exerts operational effects or the like particularly when it is applied to such an inner ear type headphone, and therefore, the present embodiment is described by way of example of this inner ear type headphone 1. Inside the inner ear type headphone 1, the drive unit 10 is provided connected to a signal line 2 and accommodated in a housing 3. In FIG. 1, in order to clearly show this drive unit 10, the drive unit 10 is taken out of the housing 3. However, needless to say, application of the drive unit 10 of this embodiment is not limited to the inner ear type headphone 1, and may be applied to various types of headphone like outer ear type headphone, and the drive unit 10 of this embodiment is applicable to a microphone and speaker.

As shown in FIG. 2, roughly, the drive unit 10 has a board 11, a land 12 and a cover 13.

The board 11 is a printed board on which a Magnetic Device Driver (MDD) for converting electric signals into sound is mounted. As shown in FIG. 2, on the back surface of this board 11 (surface in the negative direction of the x axis), there is formed the land 12. On the other hand, on the front surface of this board 11 (surface in the positive direction of the x axis, not shown) or in the direction of the front surface, there are arranged a voice coil, a diaphragm and magnets (not shown). The voice coil is wound around the center of the diaphragm and connected thereto, and an end of the diaphragm is fixed to the board 11, the cover 13, or the like. Then, the magnets are arranged so as to generate magnetic field where an attracting force or repulsive force is generated against the magnetic field of the voice coil. As a result, electric signals pass through the voice coil and the attracting force or repulsive force is generated between the voice coil and the magnets by magnetic interaction. Then, this attracting force or repulsive force vibrates the diaphragm, which outputs the sound. That is, the voice coil has a role of converting the electric signals into sound by way of the diaphragm. Here, the conducting wire L which is winding that constitutes the voice coil is drawn out to the back surface of the board 11 and fixed to the land 12.

The conducting wire L is, as described above, a winding that forms the voice coil and is drawing out to the back surface of the board 11. In other words, it can be said that the conducting wire L shown in FIG. 2 is an input and output terminal of the voice coil. This conducting wire L contains at least copper and has a property of transmitting electric signals. The material of the conducting wire L includes at least, but not limited to, the copper. The conducting wire L may be, for example, cupper wire, Copper Clad Aluminum Wire (CCAW) or the like. Here, the CCAW is light-weighted, has excellent conductivity and also is advantageous in transmitting electric signals of sound. Therefore, the conducting wire L is preferably CCAW. The description below takes the case where the conducting wire L is CCAW.

The conducting wire L, which is CCAW, has a cross section as shown in FIG. 3. That is, the conducting wire L has a core L1, a core cover film L2 and an insulating film L3. The core L1 is formed with aluminum, aluminum based alloy or the like and has roles of reducing the weight of the conducting wire L itself and transmitting electric signals. The core cover film L2 is formed with, copper, copper based alloy or the like and has roles of protecting the core L1 and enhancing the conductivity and contactivity. The insulating film L3 is formed with enamel, polyurethane or the like and roles of insulating and protecting the core L1 and the core cover film L2. In such a conducting wire L of CCAW, as the core L1 is formed with the lightweight metal such as aluminum, it becomes possible to reduce the total weight and reduce the voice coil weight to achieve high-quality sound. In order to achieve such high-quality sound, the diameter of the conducting wire L may be 70 μm or less, or more preferably 70 μm or less, which are confirmed in the tests by the inventors of the present invention.

The land 12 is formed on the back surface of the board 11, and formed with metal materials containing copper. This land 12 is preferably formed on the board 11 by printing, vapor deposition or the like. Connected to this land 12 is the conducting wire L of the voice coil as described above. Connected to the other end of the land 12 is, for example, a signal line 2. Therefore, the voice coil (not shown) and the signal line 2 formed of the conducting wire L are connected to each other via the land 12. With this structure, the signal line 2 can be firmly fixed and prevented from transferring vibration of the like to the conducting wire L. Here, connection between the land 12 and the conducting wire L or the signal line 2 made by resistance welding as described later, however, it is preferable that solder coating is made on the surface of the land 12 for excellent welding.

The picture taken of connection between the land 12 and conducting wire L of the voice coil is shown in FIG. 4.

The conducting wire L is placed on the land 12 and connected onto this land 12 by welding. Then, in the drive unit 10 of this embodiment, the conducting wire L is welded at its welding portion A to the land 12 by resistance welding. Here, in the drive unit 10 according the related art prior to the present invention, connection between the conducting wire L and the land 12 is performed by workers' manual operation of soldering. If a very thin conducting wire L like the above-mentioned CCAW is used to improve the sound quality and miniaturize the drive unit 10, connection between the conducting wire L and the land 12 is very fine work and needs highly sophisticated experiences for manual soldering. On the other hand, in the drive unit 10 of the present embodiment, they are connected to each other by resistance welding, the workers' work can be saved and error in work can be reduced thereby to maintain high quality. This resistance welding will be described in the section of the drive unit manufacturing method and the like.

In the cover 13, the board 11 and the like are fixed thereto and accommodated with the housing 3 therein. In the front surface of this cover 13 (surface in the positive direction of the x axis, not shown), there are preferably a large number of holes formed, through which the sound is output.

### [2. Drive Unit Manufacturing Apparatus]

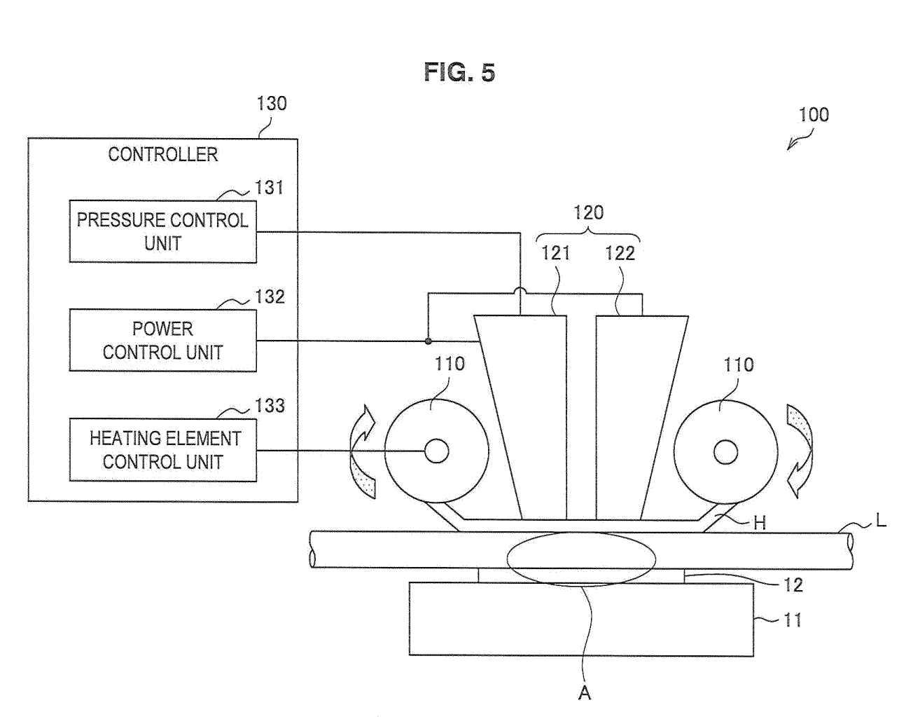

Next description is made, with reference to FIG. 5, about the structure of the drive unit manufacturing apparatus according to the first embodiment of the present invention. FIG. 5 is an explanatory view for explaining the structure of the drive unit manufacturing apparatus according to the present embodiment. Here, conditions such as a voltage applied by the drive unit manufacturing apparatus (hereinafter, also referred to as “manufacturing apparatus” simply), pressure and the like will be described with later description of the manufacturing method.

The manufacturing method 100 has reels 110, a welding head 120 and a controller 130, as shown in FIG. 5.

A heating element H is wound around each of the reels 110, and discharged at a predetermined speed. The heating element H is a resistance heating member such as Kovar and is formed into a ribbon shape having a width of 0.5, 1.0 or 1.5 mm. The Kovar contains, for example, 53% of Fe, 29% of Ni, 17% of Co and 0.2% of Cr. The reel 110 feeds the heating element H over the conducting wire L arranged on the land 12 of the board 11, that is, a welding part A, and moves the heating element continuously in the rotational direction of the reel 110. Here, the heating element H plays roles of heating the conducting wire L to be welded and land 12, and protecting the conducting wire L from a defect such as disconnection due to heating or pressure. Further, this heating element H acts to remove dust due to the insulating cover L3 of the conducting wire L welded at heating. In order to remove the dust, the heating element H is preferably moved at the appropriate speed by the reels 110.

The welding head 120 has a pair of electrodes 121, 122, ends of which pushes the heating element H in the direction of the conducting wire L and the land 12. Then, a voltage is applied between the electrodes 121, 122 to supply power to the heating element H for heat generation. Hence, the welding head 120 is preferably made of a material having conductivity, and high heat resistance and pressure tightness, or, molybdenum or the like for example.

The end of the welding head 12 pushes the heating element H in the direction of the conducting wire L as described above and supplies power to the heating element H. Then, this end is preferably formed to have such a narrow area as to maintain the pressure while assuring some degree of contact area. The area of this end is, preferably, about 0.5×0.7 mm for example.

The controller 130 has a pressure control unit 131, a power control unit 132 and a heating element control unit 133 for controlling the above-mentioned reels 110, pressure and power of the welding head 120 and the like.

The pressure control unit 31 controls a pressing force of the welding head 120 against the heating element H via a separate pressing device (not shown).

The power control unit 132 is connected to the paired electrodes 121 and 122 of the welding head 120 and controls power supply to the electrodes 121 and 122.

The heating element control unit 133 is connected to the reel 110 for controlling the feeing amount of the ribbon-shaped heating element H (also referred to as moving speed, winding amount and the like).

In this embodiment, the magnitude of the load (pressure) applied by the pressure control unit 131, the amount of power supplied by the power control unit 132 and its change over time, the speed of the heating element H fed by the heating element control unit 133 and the like are described in the following manufacturing method.

### [3. Drive Unit Manufacturing Method]

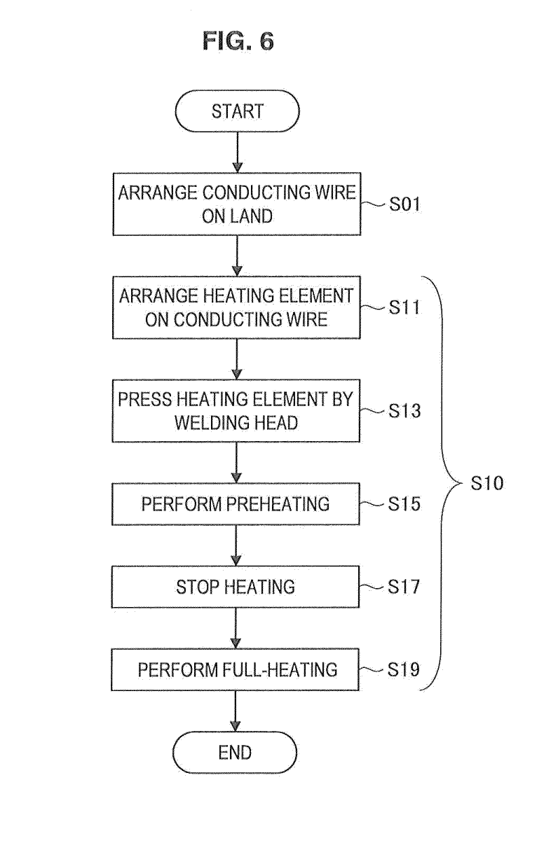

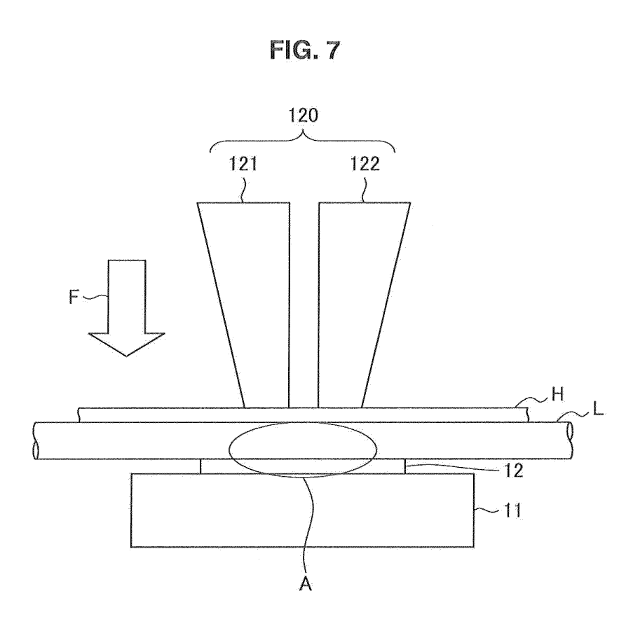

Next description is made, with reference to FIGS. 6 to 10, about the operation of the above-described drive unit manufacturing apparatus 100, that is, the drive unit manufacturing method according to an embodiment of the present invention. FIG. 6 is an explanatory view for explaining an operation of the drive unit manufacturing apparatus according to the embodiment. FIGS. 7 to 10 are explanatory views for explaining the operation of the drive unit manufacturing method according to this embodiment.

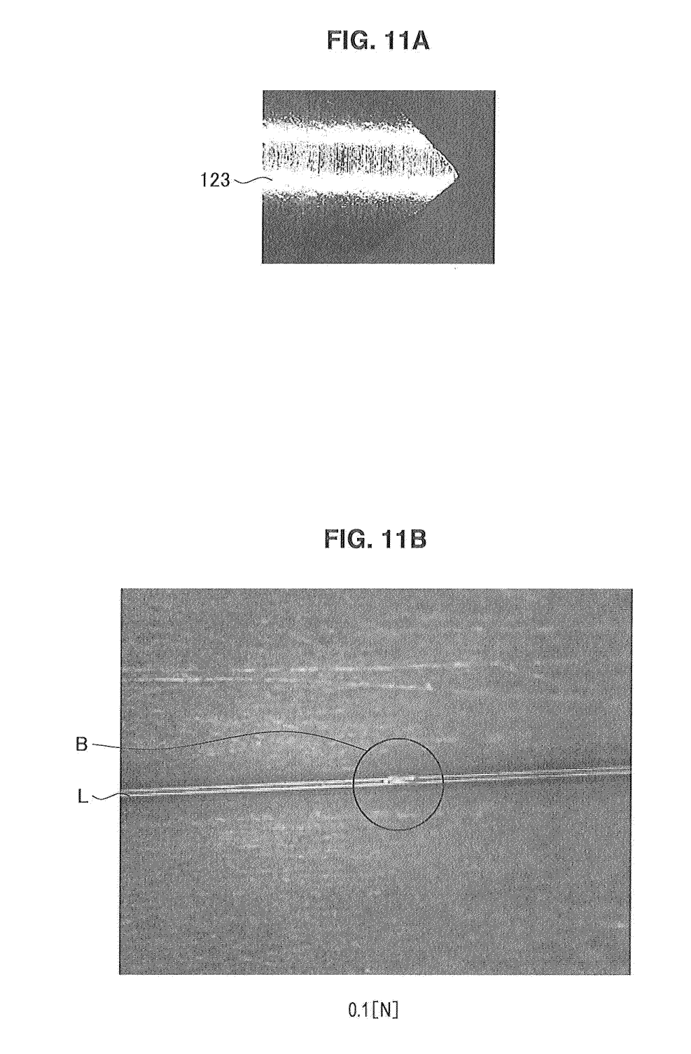

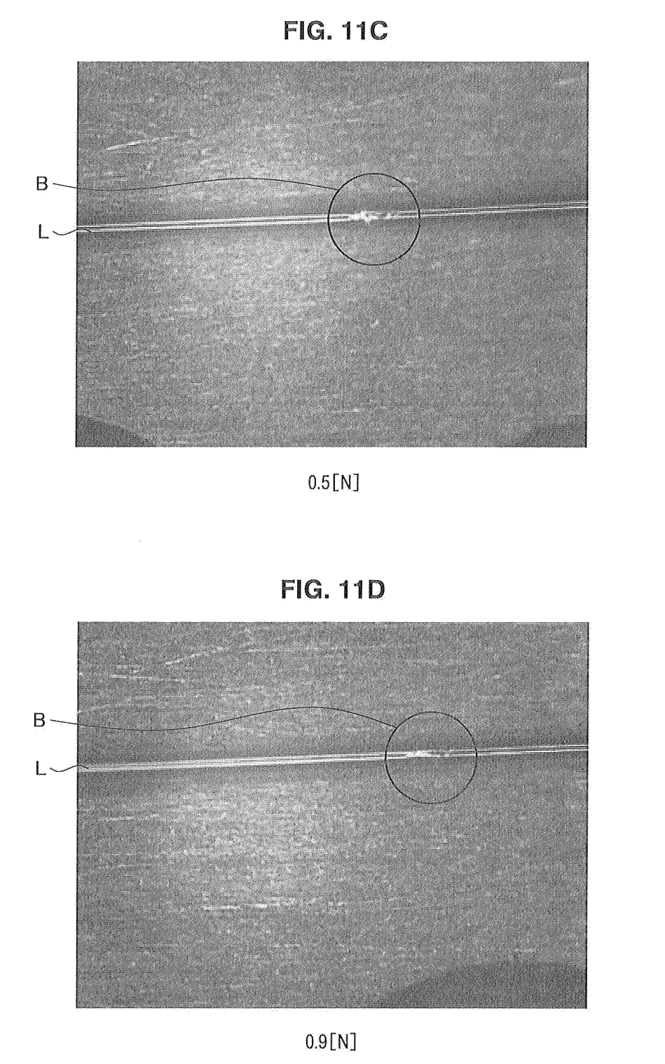

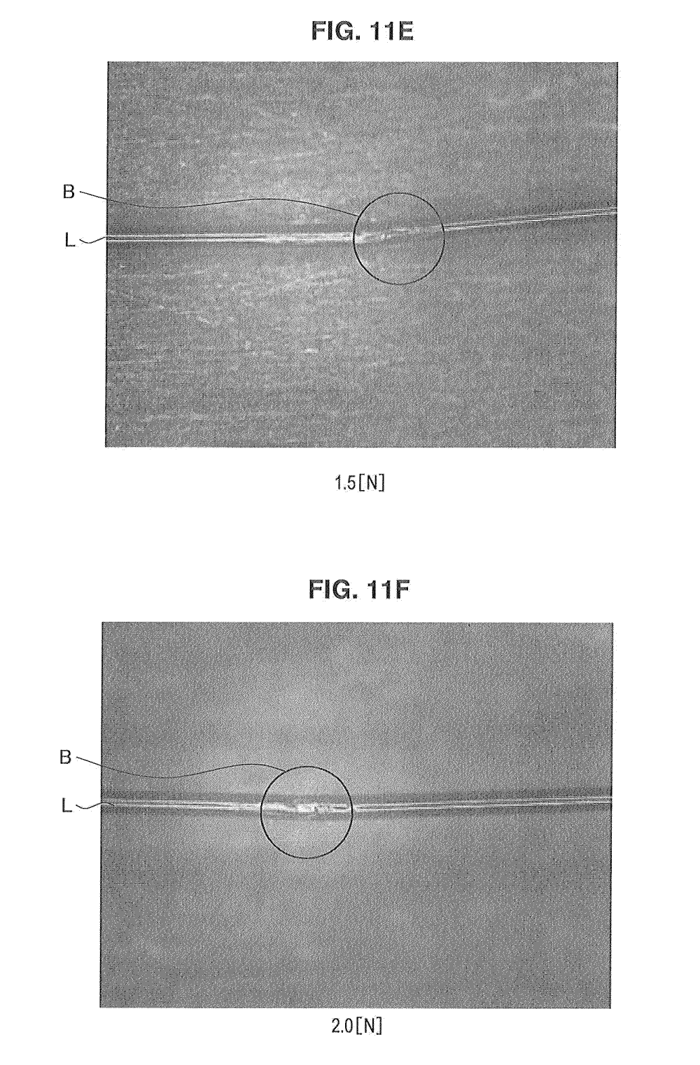

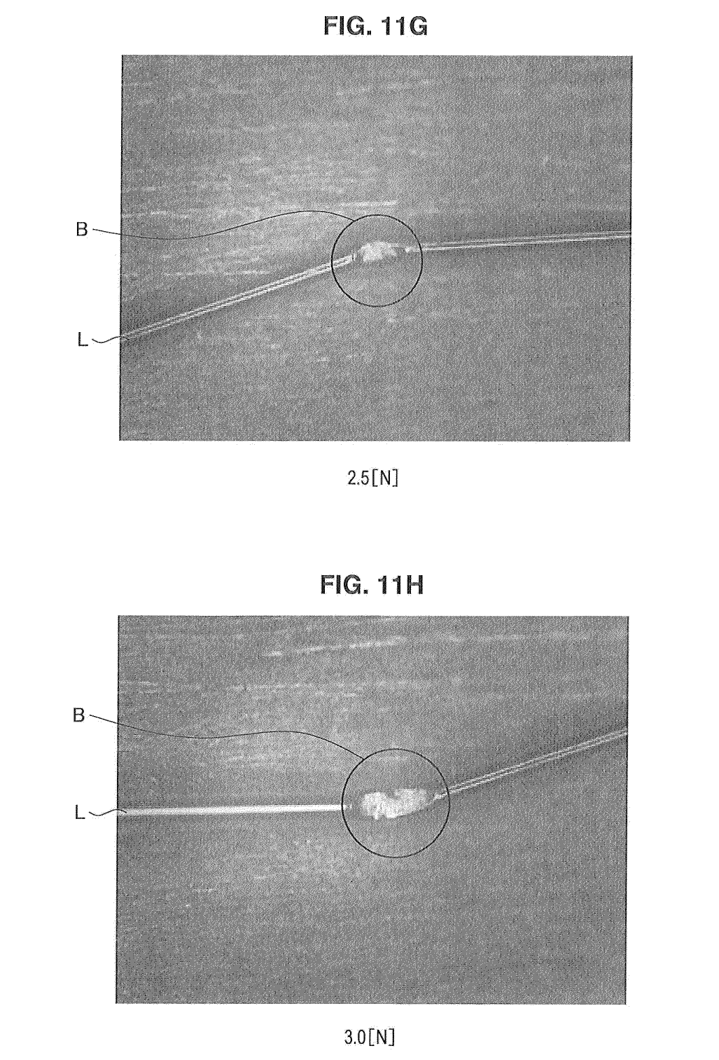

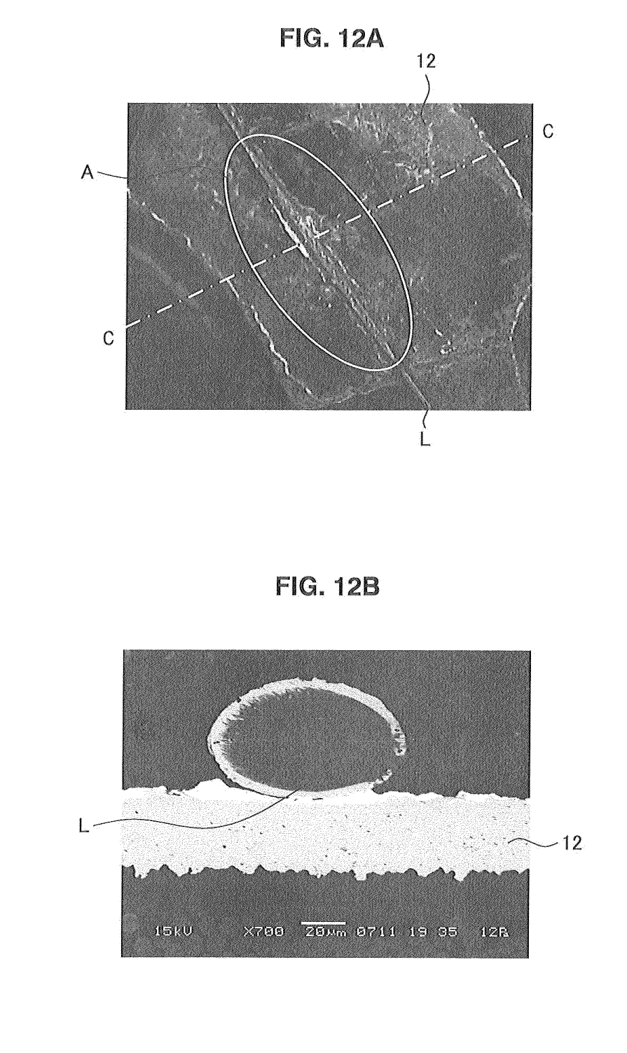

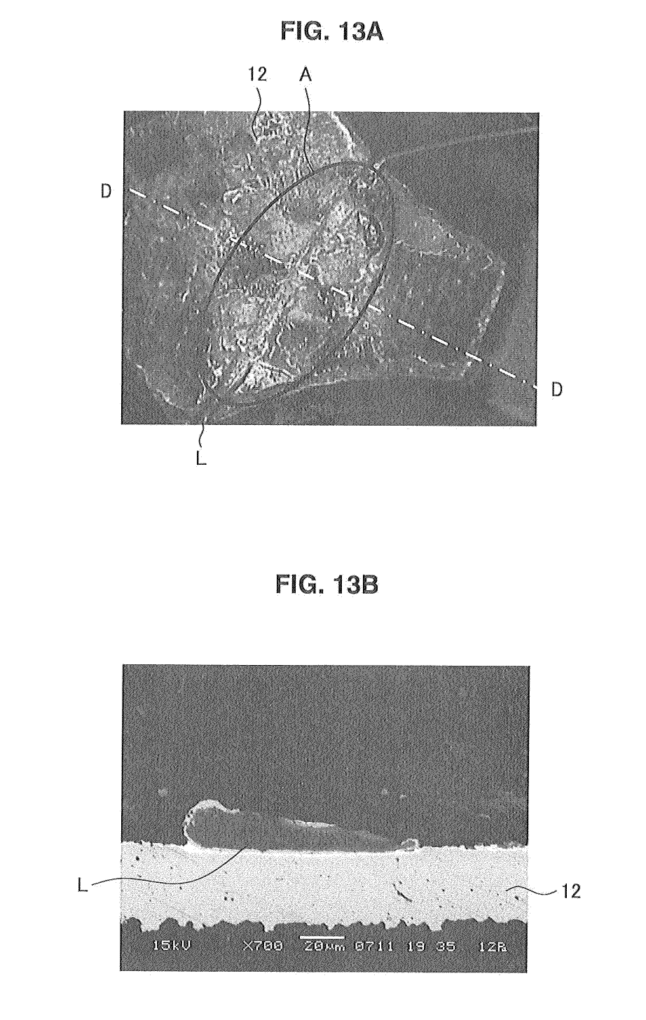

Here, in order to explain conditions of the operation of the drive unit manufacturing apparatus, references are made to FIGS. 11A to 13B when necessary. FIGS. 11A to 11H are explanatory views for explaining the pressing operation of the drive unit manufacturing apparatus according to this embodiment, and FIGS. 12A to 13B are explanatory views for explaining the full-heating operation of the drive unit manufacturing apparatus according to this embodiment.

As shown in FIG. 6, the processing of the step S01 is performed in a state that the voice coil, magnets, diaphragm and the like (not shown) are arranged on the surface of the board 11 of which the land 12 is formed on the back surface and the cover 13 and the board 11 are fixed. The step S01 is an example of the conducting wire arranging step, and in this step S01, the conducting wire L is arranged on the land 12 of the board 11. Then, the process goes to the step S10.

The step S10 is an example of the welding step. In this step S10, the conducting wire L and the land 12 are connected to each other by resistance welding. After the processing of the step S10, the operation of this drive unit manufacturing apparatus 100 ends. For more detailed explanation of this step S10, the processing of steps S11 to S19 is performed in this step S10.

In the step S11 (an example of heating element arranging step) after the step S01 as shown in FIG. 7, the heating element control unit 133, the reels 110 and the like are used to arrange the heating element H on the conducting wire L on the land 12 of the board 11. Then, the process goes to the step S13.

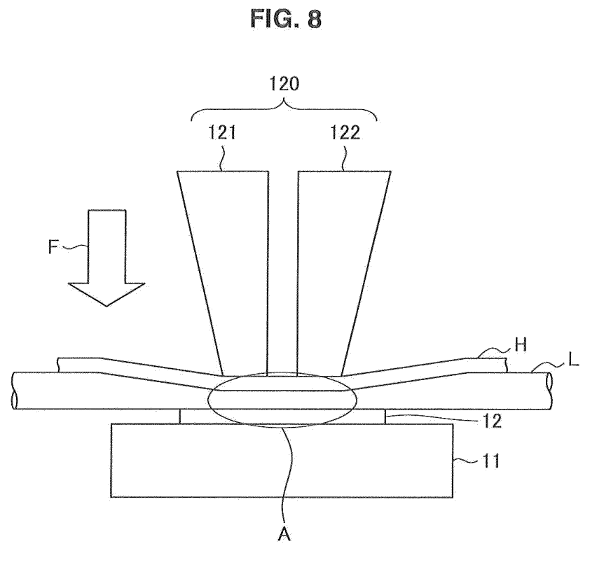

In the step S13 (an example of the pressing step), as shown in FIG. 8, the pressure control unit 131, the welding head 120 and the like are used to press the heating element H in the direction of the conducting wire L and the land 12. The force of pressure (magnitude of load) F to be applied here is set to an appropriate value controlled by the pressure control unit 131, unlike a slight tension of the welding head 120 always in contact with the heating element H to press the heating element H. The pressing force F applied by the welding head 120 is 0.1 N or more and 3.0 N or less, inclusive. As described above, the conducting wire L used in the voice coil of the drive unit 10 has a diameter of 70 μm or less, or preferably 50 μm or less to improve the sound quality and the like. When such a thin conducting wire is used, if the pressing force F is less than 0.1 N, welding of the conducting wire L and the land 12 may not be performed appropriately but there may occur bad connecting. On the other hand, if the pressing force F exceeds 3.0 N, the conducting wire L may be broken. Here, as it is difficult to measure the contact area and the like exactly, it also becomes difficult to convert this pressing force F to the pressure. However, if this pressing force F (0.1 N or more and 0.3N or less) is converted into pressure, it is preferably 0.28×10⁶ N/m² or more and 8.6×10⁶ N/m² or less. In addition, in the above-mentioned range (0.1 N or more and 0.3 N or less), the pressing force F is preferably set to about 0.1 N for the conducting wire L having a diameter of 50 μm and about 3.0 N for the conducting wire L having a diameter of 70 μm. However, the relation between the diameter of the conducting wire L and the pressing force F is not limited to this example. After this step S13, the process goes to the step S15.

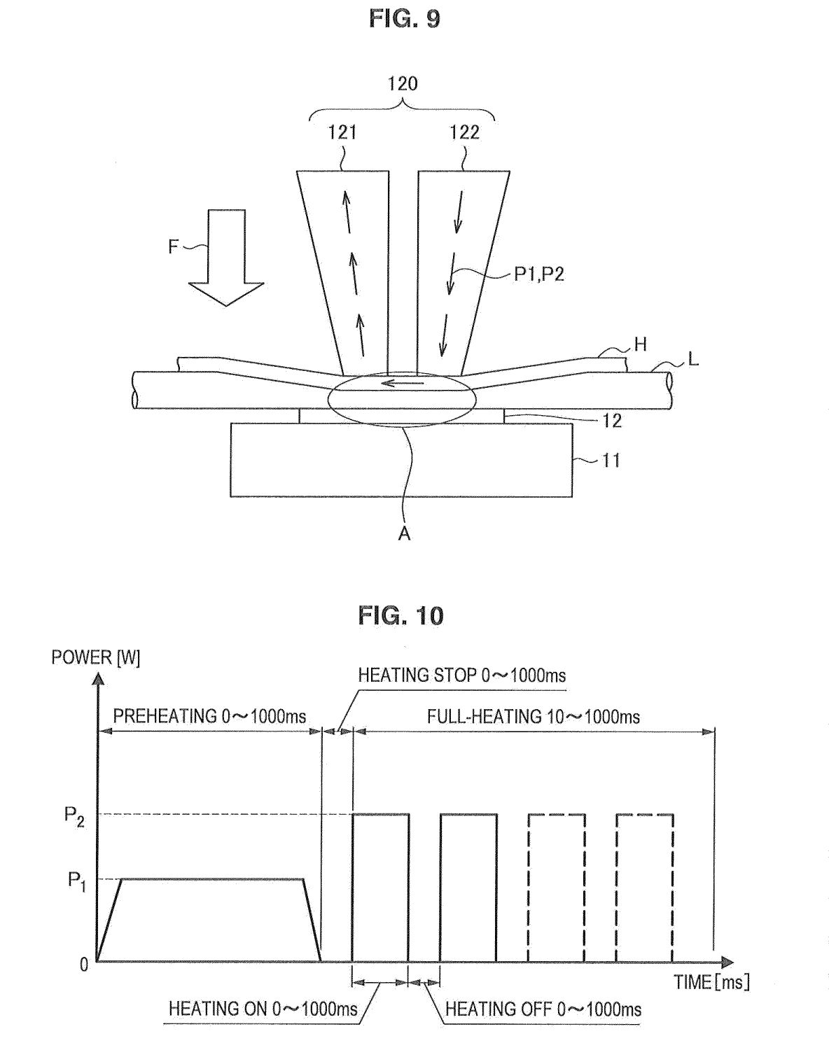

In the step S15 (an example of the preheating step), as shown in FIGS. 9 and 10, the power control unit 132 and the like are used to supply a first power P1 to the welding head 120 while the heating element H is pressed by welding head 120. Then, the first power P1 is supplied from both electrodes 121 and 122 of the welding head 120 to the heating element H, and this first power P1 is used to generate Joule heat Q (J) (=P1×t (t: time)) to cause heat generation of the heating element H. This results in preheating of the conducting wire L and the land 12 close to a part where heat is generated by the heating element H (welding part A). The period of performing this preheating is also called “preheating period”, of which the length (preheating time) is set to 0 msec or more and 1000 msec or less. Then, the first power P1 supplied in the preheating is preferably set to 40 W or less. With such preheating, the insulating film L3 of the conducting wire L is melt thereby to prevent bad welding of the later full heating (step S19). Here, when the first power P1 exceeds 40 kW, heat generated in the preheating may cause melting of the conducting part of the conducting wire L (for example, core L1 and core cover film L2). In addition, although the lower limit of this first power is not defined specifically, it is preferably set to such a power value as to be able to generate heat for preheating the land 12 and the conducting wire L sufficiently. After this step S15, the process goes to the step S17.

In the step S17 (an example of the heating stopping step), as shown in FIGS. 8 and 10, the power control unit 132 and the like are used to stop power supply to the welding head 120 in a state that the welding head 120 pressures the heating element H, and stop heating of the conducting wire L, the land 12 and the like close to the welding part A. This period for stopping heating is also called “heating stop period”, and a length of which (heating stop time) is set from 0 msec or more and 1000 msec or less. Generally, there is a time difference between power supply to the welding head 120 and temperature increase of the land 12 and the conducting wire L to heat. And, the term of heating used here is small and local heating. Therefore, although it is generally difficult to control the temperature increase of the land 12 and the conducting wire L, such heating stop period can contribute prevention of rapid heating and small variations in peak temperature. After this step S17, the process goes to the step S19.

In the step S19 (an example of the full-heating step), as shown in FIGS. 9 and 10, the power control unit 132 and the like are used to supply a second power P2 to the welding head 120 while the heating element H is pressed by the welding head 120. Then, the second power P2 is supplied from the both electrodes 121, 122 of the welding head 120 to the heating element H and this second power P2 is used to generate Joule heat Q (J) (=P2×t (t: time)) to cause the heating element H to heat again. As a result, the conducting wire L and the land 12 are full-heated close the part where heat is generated by the heating element H (welding part A). With this full heating, the conducting wire L is connected to the land 12 by welding. That is, with a heat amount of full heating, a copper component of the core cover film L2 of the conducting wire L and a copper component of the land 12 (in some cases, including solder coating) are melt so as to be fused and bonded to each other by the pressure applying them. This period for full-heating is also called full-heating period, of which a length (also called full-heating time) is set to more than 10 msec and less than 1000 msec. Then, the second power P2 supplied in full-heating is set to 10 W or more and 60 W or less. If the full-heating time is less than 10 msec, there may be caused defects of bad welding where welding may not be performed appropriately and bad connection between the conducting wire L and the land 12. This goes for the case of the second power P2 of less than 10 W. When the full-heating time is more than 1000 msec, the conducting wire L is melted too much, the core L1 may be exposed or the conducting wire L may be broken. This goes for the second power P2 exceeding 60 W. Here, there is correlation between the full-heating time and the second power P2. When the second power P2 is relatively large, it is preferable that the full-heating time is relatively short, while when the second power P2 is relatively small, it is preferable that the full-heating time is relatively long. However, in any case, the full-heating time and the amount of the second power P2 depart from the above-mentioned ranges, there may be caused defects such as band welding and break. Then, in the manufacturing apparatus 100 of the drive unit 10 according to this embodiment, excellent connection between the land 12 and the conducting wire L of the drive unit 10 can be maintained by keeping the full-heating time and the second power P2 within the above-mentioned range. In order to keep more excellent connection between the conducting wire L and the land 12, the above-mentioned second power P2 is preferably set to 20 W or more and 30 W or less. Furthermore, if the second power P2 is set within this range, it become possible to prevent the temperature of the conducting wire L from reaching the melting temperature of the core L1 (for example, aluminum).

Here, prior to this full-heating, the power control unit 132 and the like may supply the second power P2 with discontinuous pulses as shown in FIG. 10. When the full-heating is performed with discontinuous pulses, the amount of heat generated by the heating element H in full-heating can be controlled appropriately, and connection by welding of the conducting wire L and the land 12 can be controlled appropriately and easily. In this case, the length of time period for first supply of the second power P2 (Heating ON) is preferably set to 1 msec or more and 1000 msec or less. Then, a length of time period (Heating OFF) where the second power is not supplied between twp supplies of the second power P2 is preferably set to 0 msec or more and 1000 msec or less. If the length of one heating ON time is set to less than 1 msec, the amount Q (=P2×t) of heat generated by the heating element H is too small due to short time t, and there may be caused bad welding between the conducting wire L and the land 12. On the other hand, when the length of one heating ON time is set to more than 1000 msec, the amount Q of heat generated by the heating element H is too large and there may be caused a defect such as breaking of the conducting wire L. If the length of heating OFF time is set to more than 1000 msec, the time period between one heating ON time and following heating ON time becomes too long, and there may be caused bad welding between the conducting wire L and the land 12. In view of this, in the manufacturing apparatus 100 of the drive unit 10 according to this embodiment, as the second power P2 is supplied in the form of pulses at the above-mentioned cycles, connection between the conducting wire L and the land 12 in the drive unit 10 can be controlled appropriately. In this case, as the heating OFF period is provided like the above-mentioned heating stop period, it is possible to prevent rapid heating and reduce variations in peak temperatures.

### (Pressing Force)

Here, the pressing force in the above-mentioned step S13 (an example of the pressing step) is described with reference to FIGS. 11A to 11H. As described above, this pressing force is set to 0.1 N or more and 3.0 N or less, of which test examples are shown in FIGS. 11A to 11H.

First, on the land 12 of copper, the conducting wire L is arranged which is a CCAW having a diameter of 50 μm. Then, a jig 123 as shown in FIG. 11A is prepared which has the same shape as the end of the welding head 12, and this jig 123 is used to press the heating element H. In this pressing, the load applied to the jig 123 is varied and the crushing state of the conducting wire L is measured. The end of the jig 123 is set to have almost the same curvature radius R (=0.1 mm) as the end of the welding head 12. Actually, the heating element H, which is, for example, of Kovar and has a thickness of 0.02 mm, is arranged between the welding head 120 and the conducting wire L. However, as shown in FIG. 8, the heating element H under pressure is in contact with the end of the welding head 120 in such a manner that the heating element H is wound on the end of the welding head 120. Consequently, in actual pressing, the conducting wire L is pressed through the heating element H with the same curvature radius as the curvature radius R of the jig 123. Hence, in this example, the jig 123 is used in measurement, instead of the welding head 120.

Results of such pressing (pressurization) are shown in FIGS. 11B to 11H.

FIG. 11B shows a result of pressing force F of 0.1 N, FIG. 11C shows a result of pressing force F of 0.5 N, FIG. 11D shows a result of pressing force F of 0.9 N, and FIG. 11E shows a result of pressing force F of 1.5 N. Then, FIG. 11F shows a result of pressing force F of 2.0 N, FIG. 11G shows a result of pressing force F of 2.5 N, and FIG. 11H shows a result of pressing force F of 3.0 N.

As shown in FIG. 11B, it is confirmed that when the pressing force F is 0.1 N, deformation of the pressed part B of the conducting wire L is limited to relatively narrow and shallow area and the conducting wire L and the land 12 are bonded to each other under the enough force to conduct welding by later preheating, full-heating and the like. However, when the pressing force F is less than 0.1 N, it becomes difficult even to fix the conducting wire L to the land 12 and also to weld them.

On the other hand, as shown in FIG. 11H, when the pressing force F is 3.0 N, deformation of the pressed part B of the conducting wire L can be seen in the relatively wide and deep area. However, this pressing force F is not so strong as to break the conducting wire L, and even for the later welding by preheating, full-heating and the like, the welding can be performed appropriately and the aluminum is prevented from melting out of the core L1 of the conducting wire L. On the other hand, if the pressing force F is more than 3.0 N, the possibility that the defects such as breaking of the conducting wire L and melting out of the aluminum may occur is increased.

Needless to say, as shown in FIGS. 11C to 11G, when the pressing force F falls within 0.1N or more to 3.0 or less, the conducting wire L is pressed by the land 12 under excellent pressing force and welding can be performed appropriately.

### (Length of Full-Heating Time)

Here, description is made, with reference to FIGS. 12A to 13B, about the length of full-heating time in the above-mentioned step S19 (an example of the full-heating step). As described above, the length of full-heating time is set to more than 10 msec and less than 1000 msec, for which test examples are shown in FIGS. 12A to 13B.

First, on the land 12 of copper, the conducting wire L is arranged which is a CCAW having a diameter of 50 μm. On this conducting wire L, a heating element H is arranged which is of Kovar containing the above-mentioned components and has a thickness of 0.02 mm. Then, the welding head 120, which has an end having an area of about 0.5×0.7 mm, is used to press the heating element H with a pressing force of 0.1 N. Next, the first power P1 of 20 W is supplied for 15 msec to perform preheating, and then, heating is stopped for 5 msec. After that, the second power P2 of 15 W is supplied once for 10 msec, of which welding state of the land 12 and the conducting wire L is shown in FIGS. 12A and 12B, and for 1000 msec, which welding state of the land 12 and the conducting wire L is shown in FIGS. 13A and 13B. Here, FIGS. 12A and 13A are pictures showing the welding part A and FIGS. 12B and 13B are pictures showing cross sections taken along the lines C-C and D-D, respectively, of the welding part A.

As shown in FIGS. 12A and 12B, when the full-heating time is 10 msec, welding state of the land 12 and the conducting wire L is not enough and there is occurred bad welding. On the other hand, when the full-heating time is more than 10 msec, the possibility of occurrence of bad welding can be reduced substantially. In view of this, for the manufacturing apparatus 100 according to this embodiment, it is possible to greatly reduce the possibility of causing such bad welding by setting the full-heating time to more than 10 msec.

On the other hand, as shown in FIGS. 13A and 13B, when the full-heating time is 1000 msec, the conducting wire L becomes too much crushed and there may possibly cause defects of breakage of the conducting wire L, exposure of aluminum of the core L1, bad connection due to change over time. On the other hand, when the full-heating time is set to less than 1000 msec, the possibility of occurrence of such defects of the conducting wire L as described above are reduced substantially. In view of this, in the manufacturing apparatus 100 according to this embodiment, it is possible to greatly reduce the possibility of causing such defects by setting the full-heating time to less than 1000 msec.

Here, the test examples for the full-heating time more than 10 msec and less than 1000 msec, are not shown. However, if the full-heating time falls within such a range, the possibility of occurrence of the above-mentioned band welding and defects of the conducting wire L can be greatly reduced, which can be confirmed by the fact that the test examples shown in FIGS. 13A and 13B show edge of the range of the full-heating time in which the above-mentioned defects are likely to occur.

### (Relation Between Pressing Force and Full Heating Time)

The pressing force described here and the full-heating time has a relation as follows.

That is, when the pressing force is relatively large, the full-heating time may be relatively short, and when the pressing force is relatively small, the full-heating time may be relatively long. The pressing force and full-heating time are preferably determined based on this relation as long as they fall within the above-mentioned respective ranges. However, the pressing force is mainly associated with occurrence of defects of breakage of the conducting wire L and the like, while the full-heating time is associated with the degree of welding between the conducting wire L and the land 12. Then, the manufacturing apparatus 100 according to this embodiment can achieve prevention of the defects of breakage of the conducting wire L and the like and excellent welding of the conducting wire L and the land 12 by appropriately maintaining the both parameters within the above-mentioned respective ranges. Here, the amount of the second power P2 is important and may only be 10 W or more and 60 W or less, as described above. Then, the second power P2 and the full-heating time have such a relation that as the second power P2 is larger, the full-heating time may be shorter.

### [4. Example of Effect of First Embodiment]

Up to this point, description has been made about the drive unit manufacturing method according to the first embodiment of the present invention and the headphone having a drive unit manufactured by the drive unit manufacturing method. According to the drive unit manufacturing method according to the present embodiment, connection of the conducting wire L of the voice coil and the land 12 can be conducted by the resistance welding appropriately. Accordingly, there is no need for workers to have highly sophisticated working skill compared with the case of manual soldering, and also there is no need to consider lack of skill, working errors and the like of workers, and it becomes possible to always manufacture a drive unit 10 of high quality. Hence, it is possible to reduce the possibility of occurrence of the defects that are often seen in the manual soldering, such as defects of tunnel soldering, breakage, soldering ball and the like, and thereby to improve the reliability of the drive unit 10 itself. With such high reliability and higher working efficiency than that of manual operation, it is possible to enhance the manufacturing efficiency of the drive unit 10. Here, one of reasons for difficulty in improving the soldering efficiency is occurrence dust of head used in welding (blackening of melted resin) and the like. On this point, even if an automatic soldering apparatus is used, there is a need to adjust or exchanges heads for removal of such dust, which causes increase of manufacturing cost and does not take much effect. On the other hand, in the drive unit manufacturing method using resistance welding according to the present embodiment, as the welding head 120 abuts to the welding part A via an inexpensive heating element H, it is possible to easily and low-costly prevent the welding head 120 from contaminated. Besides, even if the soldering is performed using laser, uneven quality of solder itself may cause variation in absorbability and the soldering may not be conducted stably. Solder of even quality is hard to obtain and very expensive. Hence, even when the automatic soldering device or the like is used, it is difficult to realize high efficiency and achieve easy and low-cost connection between the conducting wire L and the land 12 like in the above-described drive unit manufacturing apparatus and method according to the present embodiment.

Further, with such a resistance welding, it is possible to fix the conducting wire L to the land 12 firmly as compared with soldering. Hence, it is also possible to increase the tensile strength of the conducting wire L thereby to reduce defects such as breakage. Furthermore, solder used in soldering is a material that has a property of less electric resistance and may impose a burden on the environment. The drive unit manufacturing method according to this embodiment can fix the conducting wire L and the land 12 with the use of resistance welding and without such solder. Hence, it is possible not only to reduce electric resistance loss in the connecting part and improve the sound quality of the drive unit 10, but also to reduce the burden on the environment in manufacturing.

Here, in order to improve the sound quality of the drive unit 10, it is preferable to use, in the conducting wire L of the voice coil, a very thin CCAW having a diameter of 70 μm or less (more preferably 50 μm or less). The operation of connecting such a thin conducting wire L to the land 12 is very difficult and the sound quality is hard to maintain. Therefore, if it is performed by manual soldering, the product quality is sometimes hard to control. On the other hand, in the drive unit manufacturing method according to the present embodiment, resistance welding is adopted thereby to enable easy and reliable welding connection between the thin conducting wire L and the land 12. Here, the typical resistance welding in the related art is not suitable for connecting of such a thin object and may not be used in connecting of the very thin conducting wire L and the land 12. Even if this typical resistance welding is adopted, there occur, for example, defects such as breakage of the conducting wire L, melting of core L1 material due to damage of the conducting wire L and bad connection. Such defects may significantly deteriorate the product quality of the drive unit 10, or, the core L1 is exposed to be corroded, the land 12 is oxidized, and the conducting wire L and the land 12 are disconnected due to time-varying deterioration, for example. However, in the drive unit manufacturing method according to the present embodiment, the resistance-welding connection between the conducting wire L of the voice coil and the land 12 of the board 11 inside the drive unit 10 can be realized, for a first time, by setting the above-mentioned conditions. Hence, the drive unit manufacturing method according to the present embodiment can contribute improvement of workability, product quality, reliability, manufacturing efficiency and the like.

The present invention contains subject matter related to Japanese Patent Application JP 2008-251756 filed in the Japan Patent Office on Sep. 29,2008, the entire contents of which being incorporated herein by reference.

It should be understood by those skilled in the art that various modifications, combinations, sub-combinations and alterations may occur depending on design requirements and other factors insofar as they are within the scope of the appended claims or the equivalents thereof.

1. A drive unit manufacturing method comprising:
preparing a conducting wire that contains at least copper and that forms a voice coil for conversion between sound and electric signals;
arranging the conducting wire on a land formed on a board, the voice coil being arranged on the board, and that is provided for transmitting the electric signals; and
connecting the conducting wire and the land by resistance welding.

2. The drive unit manufacturing method according to claim 1, wherein the act of connecting the conducting wire and the land comprises:
arranging a heating element on the conducting wire arranged on the land;
pressing the heating element toward the conducting wire and the land by use of a welding head having a pair of electrodes;
preheating the conducting wire and the land by supplying first power to the welding head pressing and thereby supplying the first power to the heating element to generate heat; and
full-heating the conducting wire and the land by supplying second power to the welding head pressing and thereby supplying the second power to the heating element to generate heat.

3. The drive unit manufacturing method according to claim 2, wherein a pressing force in the act of pressing is 0.1 N or more and 3.0 N or less.

4. The drive unit manufacturing method according to claim 2, wherein a time for applying the second power in the act of full-heating is more than 10 msec and less than 1000 msec.

5. The drive unit manufacturing method according to claim 2, wherein the second power supplied to the welding head in the act of full-heating is 10 W or more and 60 or less.

6. The drive unit manufacturing method according to claim 2, wherein in the act of full-heating, the second power is supplied in form of discontinuous pulses.

7. The drive unit manufacturing method according to claim 2, further comprising a heating stop act of stopping power supply to the welding head between the steps of preheating and full-heating.

8. The drive unit manufacturing method according to claim 1, wherein the conducting wire has a diameter of 70 μm or less.

9. A drive unit comprising:
a board where a voice coil for conversion between sound and electric signals is arranged;
a land formed on the board and that is provided for transmitting the electric signals; and
a conducting wire that contains at least copper to form the voice coil and that is connected to the land,
wherein the conducting wire and the land are connected to each other by resistance welding.
